(19) United States
(12) Patent Application Publication
(10) Pub. No.: US 2024/0404493 A1
(43) Pub. Date: Dec. 5, 2024

(54) INFORMATION PROCESSING APPARATUS, INFORMATION PROCESSING METHOD, AND NON-TRANSITORY MEDIUM

(71) Applicant: YAMAHA CORPORATION, Hamamatsu-shi (JP)

(72) Inventors: Takuya SHIBATA, Hamamatsu-shi (JP); Tatsuki TASHIRO, Hamamatsu-shi (JP); Ryohei TAKEUCHI, Hamamatsu-shi (JP); Yuki SAKAMOTO, Hamamatsu-shi (JP); Yu TAKAHASHI, Hamamatsu-shi (JP); Hayato YAMAKAWA, Hamamatsu-shi (JP); Yoshifumi MIZUNO, Hamamatsu-shi (JP); Jinichi KONNO, Hamamatsu-shi (JP); Yusuke OTA, Agoura Hills, CA (US)

(21) Appl. No.: 18/798,889

(22) Filed: Aug. 9, 2024

Related U.S. Application Data
(63) Continuation of application No. PCT/JP2022/040605, filed on Oct. 31, 2022.

(30) Foreign Application Priority Data
Feb. 25, 2022 (JP) 2022-027883

(51) Int. Cl. G10G 7/02; G10H 1/00

(52) U.S. Cl. CPC G10G 7/02; G10H 1/0008; G10H 2210/066

(57) ABSTRACT

An information processing apparatus for a string instrument including a string and a peg for tuning the string, the information processing apparatus includes a memory storing instructions, and a processor that implements the instructions to receive performance sound of the string instrument, estimate position information of the peg based on the received performance sound, and output guidance information for changing a position of the peg based on the estimated position information.

### CROSS REFERENCE TO RELATED APPLICATIONS

The present application is a continuation application of International Patent Application No. PCT/JP2022/040605, filed on Oct. 31, 2022, which claims priority to Japanese Patent Application No. 2022-027883, filed on Feb. 25, 2022. The contents of these applications are incorporated herein by reference in their entirety.

### BACKGROUND

### Technical Field

An embodiment of the present disclosure relates to an information processing apparatus and an information processing method that present information on tuning of a string instrument.

### Background Information

A tuning device of Patent Literature 1 is a string tuning device for a string instrument such as a guitar or the like. The tuning device of Patent Literature 1 includes a tuning peg or a machine head that provides equal or practically equal tuning sensitivity to the tuning sensitivity for a plurality of strings employed on the same musical instrument. The tuning device of Patent Literature 1 produces an equal or practically equal sound shift of a string related to one unit of rotation of the tuning peg or machine head.

An adjusting device of Patent Literature 2 includes a sound source that outputs a sound source signal for adjusting a tone of a musical instrument 400 having a wooden soundboard, a first equalizer that changes frequency characteristics of the sound source signal according to characteristics of an exciter, a second equalizer that changes the frequency characteristics of the sound source signal from the first equalizer, a spectrum analyzer that analyzes a spectrum of an adjusted sound generated by the musical instrument due to vibration from the exciter, and a controller that controls the second equalizer according to an analysis result of the spectrum.

A string instrument virtual tuning method of Patent Literature 3, in an un-tuned state, excites the strings of a string instrument and determines a standard adjustment factor for each string. For example, when a pitch is generated as a result of a string being strummed during normal performance of the instrument, the pitch generated by the string is adjusted by the standard adjustment factor and an intonation adjustment factor corresponding to an intonation error.

### CITATION LIST

### Patent Literature

Patent Literature 1: National Publication of International Patent Application No. 2012-533093
Patent Literature 2: Japanese Unexamined Patent Application Publication No. 2021-157016
Patent Literature 3: National Publication of International Patent Application No. 2014-507680

### SUMMARY

No prior art described above supports a tuning operation of a string instrument.

One aspect of the present disclosure is directed to provide an information processing apparatus that presents a user information that supports a tuning operation of a string instrument.

An information processing apparatus for a string instrument including a string and a peg for tuning the string according to an embodiment of the present disclosure includes a memory storing instructions, and a processor that implements the instructions to receive performance sound of the string instrument, estimate position information of the peg based on the received performance sound, and output guidance information for changing a position of the peg based on the estimated position information.

According to an embodiment of the present disclosure, information that supports a tuning operation of a string instrument is able to be presented to a user.

### BRIEF DESCRIPTION OF DRAWINGS

FIG. 1 is a diagram showing a configuration of an acoustic system 1.

FIG. 2 is a block diagram showing a configuration of a guitar amplifier 11.

FIG. 3 is a block diagram showing a main configuration of a user terminal 12.

FIG. 4 is a functional block diagram of an application program that a CPU 204 reads.

FIG. 5 is a flowchart showing an operation of the application program.

FIG. 6 is an external view of the user terminal 12, showing an example of a display screen according to the application program.

FIG. 7 is a flowchart showing an operation of a method of generating a learned model that a generation apparatus of the learned model performs.

FIG. 8 is an external view showing an example of guidance information displayed on a display 201 of the user terminal 12.

### DESCRIPTION OF EMBODIMENTS

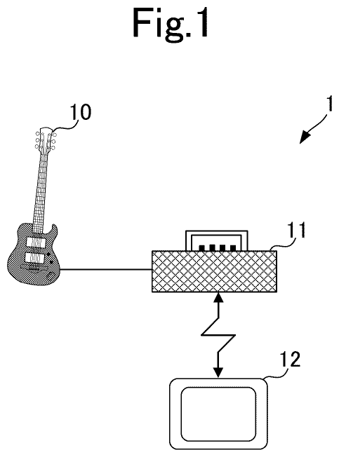

FIG. 1 is an external view showing an example of an acoustic system 1. The acoustic system 1 has an electric guitar 10, a guitar amplifier 11, and a user terminal 12.

The electric guitar 10 is an example of a string instrument with a string and a peg. Although the present embodiment shows the electric guitar 10 as an example of a string instrument, the string instrument of the present disclosure also includes others, for example, an electric bass, and an acoustic musical instrument such as a violin.

The guitar amplifier 11 is connected to the electric guitar 10 through an audio cable. In addition, the guitar amplifier 11 is connected to the user terminal 12 by wireless communication such as Bluetooth (registered trademark) or wireless LAN. The electric guitar 10 outputs an analog audio signal according to performance sound, to the guitar amplifier 11. It is to be noted that, in a case in which the string instrument is an acoustic musical instrument, an audio signal is inputted into the guitar amplifier 11 by use of a microphone or a pickup.

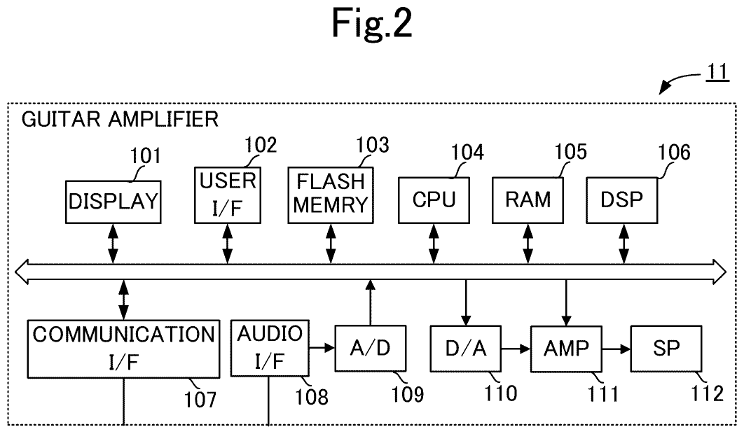

FIG. 2 is a block diagram showing a configuration of the guitar amplifier 11. The guitar amplifier 11 includes a display 101, a user interface (I/F) 102, a flash memory 103, a CPU 104, a RAM 105, a DSP 106, a communication I/F 107, an audio I/F 108, an A/D converter 109, a D/A converter 110, an amplifier 111, and a speaker 112.

The display 101 includes an LED, an LCD (Liquid Crystal Display), or an OLED (Organic Light-Emitting Diode), for example, and displays a state of the guitar amplifier 11, or the like.

The user I/F 102 includes a knob, a switch, or a button, and receives an operation by a user. In addition, the user I/F 102 may be a touch panel stacked on the LCD of the display 101.

The CPU 104 reads various programs stored in the flash memory 103 being a storage medium to the RAM 105 and controls the guitar amplifier 11. For example, the CPU 104 receives a parameter according to signal processing through the user I/F 102 and controls the DSP 106 and the amplifier 111.

The communication I/F 107 is connected to another apparatus such as the user terminal 12, for example, through Bluetooth (registered trademark) or wireless LAN.

The audio I/F 108 has an analog audio terminal. The audio I/F 108 receives the analog audio signal from the electric guitar 10 through the audio cable.

The A/D converter 109 converts the analog audio signal received by the audio I/F 108, into a digital audio signal.

The DSP 106 performs various types of signal processing such as effects, on the digital audio signal. The parameter according to the signal processing is received through the user I/F 102. The DSP 106 outputs the digital audio signal on which the signal processing has been performed, to the D/A converter 110.

The CPU 104 sends the digital audio signal on which the signal processing has been performed by the DSP 106 or the digital audio signal before the signal processing is performed, to the user terminal 12 through the communication I/F 107.

The D/A converter 110 converts the digital audio signal received from the DSP 106 into an analog audio signal. The amplifier 111 amplifies the analog audio signal. The parameter according to amplification is received through the user I/F 102.

The speaker 112 outputs the performance sound of the electric guitar 10 based on the analog audio signal amplified by the amplifier 111.

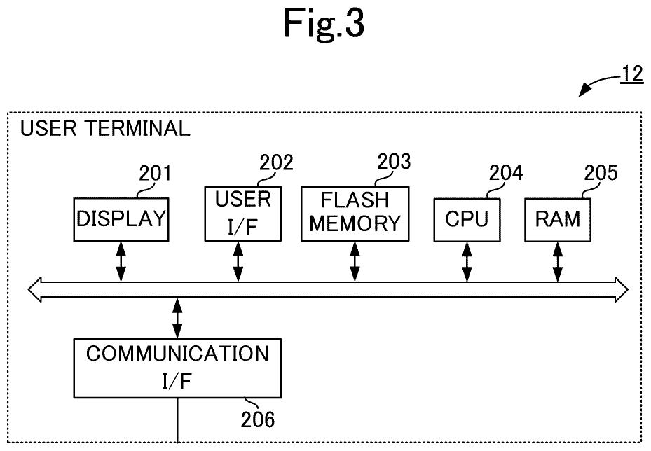

FIG. 3 is a block diagram showing a configuration of the user terminal 12. The user terminal 12 is an information processing apparatus such as a personal computer or a smartphone. The user terminal 12 includes a display 201, a user I/F 202, a flash memory 203, a CPU 204, a RAM 205, and a communication I/F 206.

The display 201 includes an LED, an LCD, or an OLED, for example, and displays various types of information. The user I/F 202 is a touch panel stacked on the LCD or OLED of the display 201. Alternatively, the user I/F 202 may be a keyboard, a mouse, or the like. In a case in which the user I/F 202 is a touch panel, the user I/F 202 constitutes a GUI (Graphical User Interface) together with the display 201.

The CPU 204 is a controller that controls an operation of the user terminal 12. The CPU 204 reads and executes a predetermined program such as an application program stored in the flash memory 203 being a storage medium to the RAM 205 and performs various types of operations. It is to be noted that the program may be stored in a server (not shown). The CPU 204 may download the program from the server through a network and may execute the program.

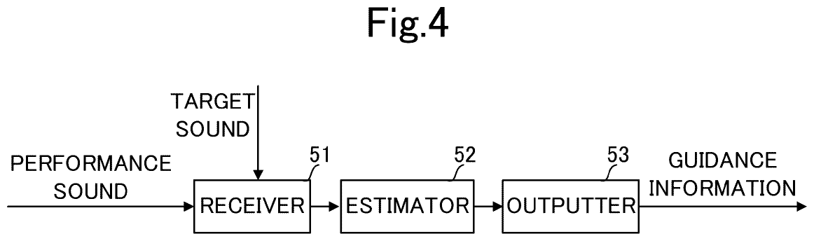

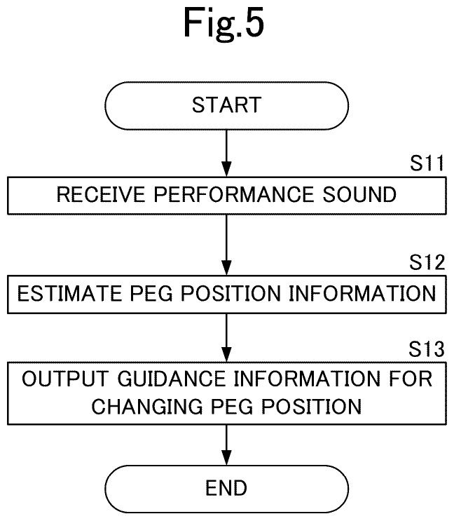

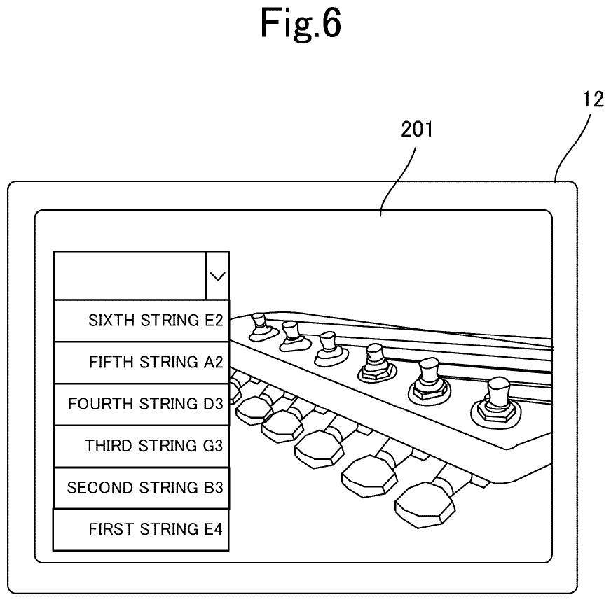

FIG. 4 is a functional block diagram of the application program that the CPU 204 reads. The CPU 204 configures a receiver 51, an estimator 52, and an outputter 53 by the read application program. FIG. 5 is a flowchart showing an operation of an information processing method by the application program. FIG. 6 is an external view of the user terminal 12, showing an example of a display screen according to the application program.

The receiver 51 receives the digital audio signal according to the performance sound of the electric guitar 10 from the guitar amplifier 11 through the communication I/F 206 (S11). In addition, in this example, the receiver 51 receives information on target sound of tuning. For example, the CPU 204 displays a selection screen of a string to be tuned, on the display 201.

The receiver 51, as shown in FIG. 6, displays an image of a peg portion of the guitar, and a selection box for selecting the string to be tuned, on the display 201. The selection box is, for example, a GUI for selecting any of a sixth string (pitch: E2), a fifth string (pitch: A2), a fourth string (pitch: D3), a third string (pitch: G3), a second string (pitch: B3), or a first string (E4) of the guitar.

The user selects the string to be tuned, or a target pitch through the user I/F 202 of the touch panel. Accordingly, the receiver 51 receives information on target sound. Subsequently, the user sounds the string selected among a plurality of strings of the electric guitar 10, with an open string. Accordingly, the receiver 51 receives the digital audio signal according to the performance sound of the electric guitar 10 from the guitar amplifier 11.

Next, the estimator 52 estimates position information of the peg, based on the performance sound received by the receiver 51 (S12). The position information of the peg includes information on a direction and amount of rotation of the peg, for example.

For example, the estimator 52 estimates the position information of the peg, based on a learned model (a trained model) that has learned a relationship between the performance sound of the electric guitar 10 and the position information of the peg of the electric guitar 10 by a DNN (Deep Neural Network).

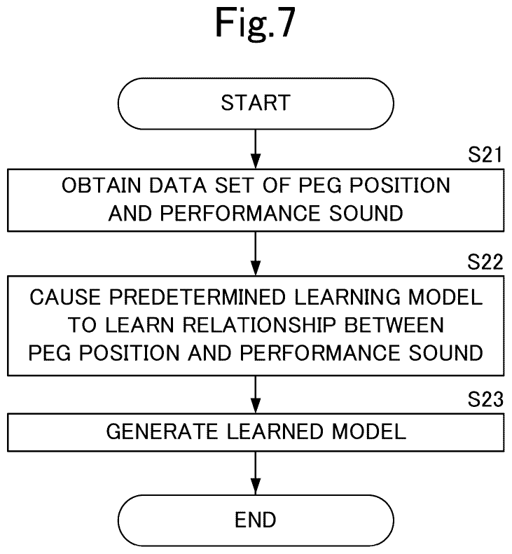

FIG. 7 is a flowchart showing an operation of a method of generating the learned model that a generation apparatus of the learned model performs. The generation apparatus of the learned model is achieved by a program executed by a computer (a server) used by a musical instrument manufacturer, for example. The generation apparatus of the learned model, as a learning phase, obtains a large number of data sets (learning data) that include the position of the peg of the electric guitar 10, and the performance sound of the electric guitar 10 in each position of the peg (S21). The generation apparatus of the learned model causes a predetermined learning model to learn a relationship between the position of the peg and the performance sound by use of a predetermined algorithm (S22). The position of the peg may be estimated from an image captured by a camera, for example, or may be detected by attaching a sensor such as a rotary encoder, to the peg.

An algorithm to cause the learning model to learn is not limited and any machine learning algorithm such as a CNN (Convolutional Neural Network) or an RNN (Recurrent Neural Network) is able to be used. The machine learning algorithm may include supervised learning, unsupervised learning, semi-supervised learning, reinforcement learning, inverse reinforcement learning, active learning, or transfer learning. In addition, the estimator 52 may cause the learning model to learn by use of the machine learning model such as an HMM (Hidden Markov Model) or an SVM (Support Vector Machine).

A tone pitch when the open string of the electric guitar 10 is played is determined by the position of the peg. In short, the position of the peg and the performance sound have a correlation. Therefore, the generation apparatus of the learned model causes the predetermined learning model to learn the relationship between the position of the peg and the performance sound and generates a learned model (S23).

The estimator 52 obtains the learned model that is the result of learning the relationship between the position of the peg and the performance sound, from the generation apparatus (a server of a musical instrument manufacturer, for example) of the learned model through the network. The estimator 52, as an execution phase, obtains the direction and amount of rotation of the peg of the electric guitar 10, by the learned model, with respect to a pitch difference between the pitch of the received current performance sound and the target pitch. More specifically, the estimator 52, by the learned model, obtains the direction and amount of rotation of the peg of the electric guitar 10 for setting the pitch difference between the pitch of the received performance sound and the target pitch to 0.

The outputter 53 outputs guidance information for changing the position of the peg based on an estimation result of the estimator 52 (S13). For example, the outputter 53 outputs an image showing the direction and amount of rotation of the peg to the display 201.

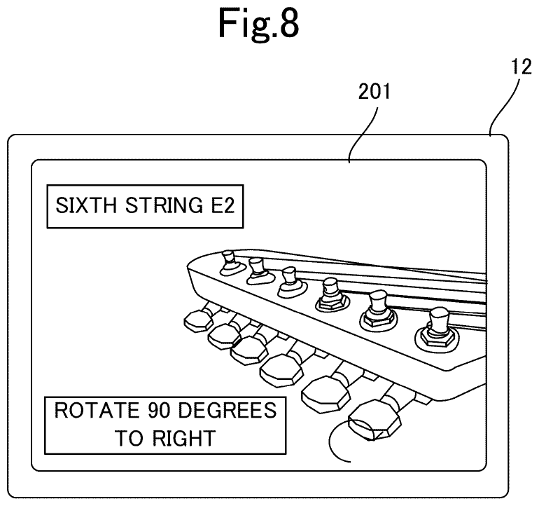

FIG. 8 is an external view showing an example of guidance information displayed on the display 201 of the user terminal 12. The outputter 53, as shown in FIG. 8, displays the image of the peg portion of the guitar, a text showing the string (the sixth string: E2 in the example of FIG. 8) to be tuned, and a text showing the direction and amount of rotation of the peg, on the display 201. The user performs tuning by rotating the peg of the electric guitar 10 with reference to the guidance information. In the example of FIG. 8, a text of “rotate 90 degrees to the right,” an image of the peg corresponding to the sixth string, and an image prompting rotation are displayed on the display 201, so that the user performs tuning by rotating the peg corresponding to the sixth string 90 degrees to the right. It is to be noted that the guidance information may also be text information such as “loose,” “fasten,” or “make a half turn to the right,” or may be guidance with a voice. Alternatively, the guidance information may be lighting or non-lighting of a plurality of LEDs. For example, the user terminal 12 may show that the peg is to be rotated to the right by lighting an LED displayed as the “right”. In addition, the user terminal 12 may show the amount of rotation by the lighting number of LEDs. For example, in a case in which the required amount of rotation is large, a large number of LEDs are lighted.

In addition, the user terminal 12 may detect a change in the received performance sound, in a case in which the user rotates the peg. The user terminal 12 may output warning information such as “the direction of rotation is opposite” as the guidance information, in a case in which the pitch difference between the pitch of the received performance sound and the target pitch is increased.

In such a manner, the user terminal 12 according to the present embodiment, the information that supports a tuning operation of the string instrument is able to be presented to the user. As a result, the user, only by sounding the string to be tuned in the electric guitar 10, can easily determine in which direction and how much the peg of the target string should be rotated to be tunable.

### (First Modification)

In the above embodiment, the receiver 51 receives the target sound (the string to be tuned, for example). However, the receiver 51 may automatically determine the target sound. In this case, a configuration that receives the target sound is not necessary. For example, the receiver 51 automatically determines the nearest pitch to the pitch of the received performance sound to the target sound. In this case, the user performs tuning by relying on own ears to some extent. The user can easily determine in which direction and how much the peg of the target string needs to be rotated to complete the tuning, after performing a certain amount of tuning.

Alternatively, even in a case in which the user completes the tuning by using a tuner before a performance, the tuning may shift during the performance. A user terminal 12 of a first modification receives performance sound by the tuning shifted during the performance, automatically determines the nearest pitch to the pitch of the received performance sound to the target sound and presents information on the direction and amount of rotation of the peg of the electric guitar 10. Therefore, the user can perceive that the tuning has shifted during the performance without using a tuner and can also correct the shifted tuning.

### (Second Modification)

In the above embodiment, the estimator 52 estimates the position information of the peg based on the learned model that has learned the relationship between the performance sound of the string instrument and the position information of the peg of the string instrument. However, the estimator 52 may estimate the position information of the peg with reference to a table that defines the relationship between the performance sound of the string instrument and the position information of the peg of the string instrument. The table is previously registered in the flash memory 203 of the user terminal 12 or in database of a not-shown server.

As a result, the user terminal 12 is also able to present the user the information that supports the tuning operation of the string instrument, without using an artificial intelligence algorithm.

### (Third Modification)

In the above embodiment, the tuning of the sixth string is shown as an example. However, the string instrument such as the electric guitar 10 includes a plurality of strings and a plurality of pegs, each peg corresponding to one of the plurality of strings. Therefore, it is preferable to cause the learned model to learn the relationship between performance sound and position information for each peg with respect to the respective string, among the plurality of strings. The estimator 52 obtains the performance sound of each string, respectively, and estimates the position information of a corresponding peg, respectively.

As a result, the user terminal 12 is able to present the user the information that supports a tuning operation for each string with high accuracy.

### (Fourth Modification)

A receiver 51 according to a fourth modification further receives environmental information. The environmental information includes, for example, information on a performance venue, information on humidity, temperature, or atmospheric pressure, or the like. The environmental information may be received from a user through the user I/F 202 or may be received by a not-shown sensor.

The environmental information is one of factors that affect tuning. The tuning is shifted by a change in these environments in many cases. An estimator 52 according to the fourth modification estimates the position information of the peg by use of the learned model that has learned the relationship between the performance sound and the environmental information, and the position information of the peg.

As a result, the user can know a tuning shift that occurs by a change in the environment such as humidity.

### (Fifth Modification)

A receiver 51 according to a fifth modification further receives number-of-people information. The number-of-people information may be received from a user through the user I/F 202 or may be received by capturing the periphery of the user terminal 12, for example, by a not-shown camera and recognizing a person from a captured image.

The number of people is also one of factors that affect tuning. The tuning is shifted by a change in the number of people in many cases. An estimator 52 according to the fifth modification estimates the position information of the peg by use of the learned model that has learned the relationship between the performance sound and the number-of-people information, and the position information of the peg.

In addition, the estimator 52 according to the fifth modification may estimate the position information of the peg by use of the learned model that has learned the relationship between the performance sound, the environmental information, and the number-of-people information, and the position information of the peg.

As a result, the user can know a tuning shift that occurs by a change in the number of people.

### (Sixth Modification)

A receiver 51 according to a sixth modification further receives string information. The string information, for example, is a string material, a string thickness, presence of coating, a type of coating material, a string use time, or the like. Alternatively, the string information may include information on a string manufacturer or a string product name. The string information may be received from a user through the user I/F 202 or may be received by capturing a string package, for example, by a not-shown camera and recognizing a string manufacturer, a product name, a manufacturing date, or the like, from a captured image.

The string information is also one of factors that affect tuning. For example, when a peg is rotated by the same amount and in the same direction, an amount of pitch change differs between a string with a long use time and a string with a short use time. Alternatively, when a peg is rotated by the same amount and in the same direction, the amount of pitch change may differ in different string materials or different string thicknesses.

An estimator 52 according to the sixth modification estimates the position information of the peg by use of the learned model that has learned the relationship between the performance sound and the string information, and the position information of the peg.

In addition, for example, even in a case in which changes in the same temperature and humidity occur, the amount of tuning shift differs in different string materials or different string thicknesses. Therefore, an estimator 52 according to the sixth modification may estimate the position information of the peg by use of the learned model that has learned the relationship between the performance sound, the environmental information, and the string information, and the position information of the peg.

In addition, the estimator 52 according to the sixth modification may estimate the position information of the peg by use of the learned model that has learned the relationship between the performance sound, the string information, and the number-of-people information, and the position information of the peg. Moreover, the estimator 52 according to the sixth modification may estimate the position information of the peg by use of the learned model that has learned the relationship between the performance sound, the environmental information, the string information, and the number-of-people information, and the position information of the peg.

As a result, the user terminal 12 is able to present the user information that supports a difference in tuning by different string materials, different string thicknesses, or the like.

### (Seventh Modification)

A receiver 51 according to a seventh modification receives frequency information related to a target tuning frequency. A user sets any of 440 Hz, 441 Hz, or 442 Hz, for example, as the target tuning frequency. The frequency information is received from the user through the user I/F 202.

The estimator 52 estimates the position information of the peg based on the received performance sound and frequency information.

As a result, the user terminal 12 is able to present the user information that supports a tuning operation to match a tuning frequency of other performers who perform together with the user.

### (Eighth Modification)

The above embodiment shows an example in which the user terminal 12 receives performance sound from an open string. However, the receiver 51 may receive performance sound of different pitches from the same strings, such as performance sound from fret held down, not an open string. In this case, the estimator 52 estimates the position information of the peg based on the performance sound of a plurality of different pitches. In this case, the receiver 51 automatically determines the nearest pitch to the pitch of the received performance sound to the target sound.

The estimator 52 previously learns a direction and amount of rotation of the peg of the electric guitar 10 for setting the pitch difference between the pitch of the performance sound from each fret held down and a target pitch to 0, for each string. The estimator 52 obtains the direction and amount of rotation of the peg of the electric guitar 10 by the learned model.

In addition, the receiver 51 may receive music data of a musical piece to be performed. The receiver 51 receives the music data of the musical piece to be performed through the user I/F 202. In this case, the receiver 51 receives the music data as target sound. The estimator 52 previously learns a direction and amount of rotation of the peg of the electric guitar 10 for setting the pitch difference between the received performance sound and the target sound of the music data to 0. The estimator 52 obtains the direction and amount of rotation of the peg of the electric guitar 10 by the learned model.

Accordingly, the user terminal 12 receives the performance sound by the tuning shifted during the performance and presents the information on the direction and amount of rotation of the peg of the electric guitar 10, based on the pitch difference with the target sound determined from the music data. Therefore, a user can perceive that the tuning has shifted during the performance without using a tuner and can also correct the shifted tuning.

As a result, the user terminal 12 is able to present the user the information that supports a tuning operation even during the performance of the user.

### (Ninth Modification)

A receiver 51 according to a ninth modification further receives musical instrument information. The musical instrument information includes, for example, a manufacture name of the musical instrument, a product name, a use time, a name of a component used for the musical instrument, or the like.

The musical instrument information may be received from a user through the user I/F 202, or may be received by capturing a musical instrument, for example, by a not-shown camera and recognizing a musical instrument manufacturer, a product name or a name of a component used for the musical instrument, a manufacturing date, or the like, from a captured image.

The musical instrument information is also one of factors that affect tuning. For example, when a peg is rotated by the same amount and in the same direction, the amount of pitch change differs between a musical instrument with a long use time and a musical instrument with a short use time. Alternatively, in a case in which a component such as a bridge is different, when a peg is rotated by the same amount and in the same direction, the amount of pitch change may differ.

An estimator 52 according to the ninth modification estimates the position information of the peg by use of the learned model that has learned the relationship between the performance sound and the musical instrument information, and the position information of the peg. The configuration of the ninth modification is also able to be combined with any of the above first modification to eighth modification.

### (Tenth Modification)

A user terminal 12 of a tenth modification performs generation of the learned model being in the learning phase shown in FIG. 7, and output of guidance information of the peg being in the execution phase shown in FIG. 5. In other words, one apparatus may perform an operation in the learning phase of the learning model and an operation in the execution phase of the learned model. In addition, a server may be the information processing apparatus of the present disclosure. In other words, the server may perform the operation in the learning phase of the learning model and the operation in the execution phase of the learned model. In this case, the user terminal 12, through the network, sends to the server the information that shows the performance sound of the electric guitar 10 and a target pitch, and receives the information on the direction and amount of rotation of the peg, from the server.

The description of the present embodiments is illustrative in all points and should not be construed to limit the present disclosure. The scope of the present disclosure is defined not by the foregoing embodiments but by the following claims. Further, the scope of the present disclosure includes the scopes of the claims and the scopes of equivalents.

For example, the above embodiment shows the user terminal 12 as an example of the information processing apparatus of the present disclosure. However, the guitar amplifier 11 may correspond to the information processing apparatus of the present disclosure. In this case, the guitar amplifier 11 receives the performance sound of a string instrument and estimates the position information of a peg based on the received performance sound, and outputs the guidance information for changing the position of the peg. In addition, the electric guitar 10 may correspond to the information processing apparatus of the present disclosure. In this case, the electric guitar 10 may include a display and may display the guidance information for changing the position of the peg on the display. Alternatively, the electric guitar 10 may include a speaker and may output the guidance information with a voice. In addition, in the above embodiment, although the electric guitar 10 is shown as an example of the string instrument of the present disclosure, an acoustic string instrument is also included in the string instrument of the present disclosure.

In addition, in the above embodiment, the user terminal 12, although receiving the performance sound of the electric guitar 10 through the guitar amplifier 11, may receive the performance sound of a musical instrument by a microphone (not shown) of the user terminal 12.

What is claimed is:

1. An information processing for a string apparatus instrument including a string and a peg for tuning the string, the information processing apparatus comprising:
a memory storing instructions; and
a processor that implements the instructions to:
receive performance sound of the string instrument;
estimate position information of the peg based on the received performance sound; and
output guidance information for changing a position of the peg based on the estimated position information.

2. The information processing apparatus according to claim 1, wherein:
the processor implements the instructions to receive target sound, and
the processor estimates the position information of the peg to reduce a pitch difference between pitches of the received target sound and the received performance sound.

3. The information processing apparatus according to claim 1, wherein the processor estimates the position information of the peg based on a learned model that has learned a relationship between the performance sound of the string instrument and the position information of the peg.

4. The information processing apparatus according to claim 3, further including:
a plurality of strings, including the string,
a plurality of pegs, including the peg, each peg corresponding to one of the plurality of strings, and
the learned model has learned the relationship between the performance sound and the position information for each peg with respect to the respective string, among the plurality of strings.

5. The information processing apparatus according to claim 3, wherein:
the learned model has further learned a relationship between environmental information and the position information,
the processor implements the instructions to receive the environmental information, and
the processor further estimates the position information based on the environmental information.

6. The information processing apparatus according to claim 3, wherein:
the learned model has further learned a relationship between number-of-people information and the position information,
the processor implements the instructions to receive the number-of-people information, and
the processor further estimates the position information based on the number-of-people information.

7. The information processing apparatus according to claim 3, wherein:
the learned model has further learned a relationship between string information and the position information,
the processor implements the instructions to receive the string information, and
the processor further estimates the position information based on the string information.

8. The information processing apparatus according to claim 1, wherein:
the processor implements the instructions to receive frequency information related to a target tuning frequency, and
the processor estimates the position information based on the received performance sound and frequency information.

9. The information processing apparatus according to claim 1, wherein:
the performance sound includes performance sounds of a plurality of different pitches, and
the processor estimates the position information of the peg based on the performance sounds of the plurality of different pitches.

10. An information processing method for a string instrument including a string and a peg for tuning the string, the information processing method comprising:
receiving performance sound of the string instrument;
estimating position information of the peg based on the received performance sound; and
outputting guidance information for changing a position of the peg based on the estimated position information.

11. The information processing method according to claim 10, further comprising:
receiving target sound,
wherein the estimating estimates the position information of the peg to reduce a pitch difference between pitches of the received target sound and the received performance sound.

12. The information processing method according to claim 10, wherein the estimating estimates the position information of the peg based on a learned model that has learned a relationship between the performance sound of the string instrument and the position information of the peg.

13. A non-transitory medium storing a program executable by a computer to execute an information processing method for a string instrument including a string and a peg for tuning the string, the information processing method comprising:
receiving performance sound of the string instrument;
estimating position information of the peg based on the received performance sound; and
outputting guidance information for changing a position of the peg based on the estimated position information.

14. The non-transitory medium according to claim 13, further comprising:
receiving target sound,
wherein the estimating estimates the position information of the peg to reduce a pitch difference between pitches of the received target sound and the received performance sound.

15. The non-transitory medium according to claim 13, wherein the estimating estimates the position information of the peg based on a learned model that has learned a relationship between the performance sound of the string instrument and the position information of the peg.
